(19) United States
(12) Patent Application Publication
(10) Pub. No.: US 2006/0156744 A1
(43) Pub. Date: Jul. 20, 2006

(54) Liquefied natural gas floating storage regasification unit

(76) Inventors: James Milne Cusiter, London (GB); David George Michael Carpenter, London (GB); Rene Spaarman, London (GB); Andrew Neil Stephens, London (GB); Steven James Bowring, Houston, TX (US); Eveline Iris Otten, The Hague (NL); Harke Jan Meek, Houston, TX (US)

Correspondence Address: SHELL OIL COMPANY, P O BOX 2463, HOUSTON, TX, 772522463, US

(21) Appl. No.: 11/268,383

(22) Filed: Nov. 7, 2005

Related U.S. Application Data
(60) Provisional application No. 60/626,041, filed on Nov. 8, 2004.

(51) Int. Cl. F17C 9/02; F17C 13/08

(52) U.S. Cl. 62/50.2; 62/53.2

(57) ABSTRACT

An offshore liquefied natural gas floating storage regasification unit that may receive, store, and process liquefied natural gas from carriers. A floating storage regasification unit may include transfer equipment to offload liquefied natural gas from a carrier, a first mooring system to provide for mooring of a floating storage regasification unit at a location in a body of water, a second mooring system to provide for mooring a carrier to the floating storage regasification unit, and combinations thereof. A portion of the floating storage regasification unit may be composed of a double-hull containment structure.

### CROSS-REFERENCE TO RELATED APPLICATIONS

This application claims the benefit of U.S. Provisional Application No. 60/626,041, filed Nov. , 2004 which is incorporated herein by reference.

### BACKGROUND OF THE INVENTION

1. Field of Invention

The invention generally relates to structures configured to store liquefied natural gas and distribute natural gas. More specifically the invention relates to liquefied natural gas processing.

2. Description of Related Art

Natural gas is becoming a fuel of choice for power generation in the U.S. and other countries. Natural gas is an efficient fuel source that produces lower pollutant emissions than many other fuel sources. Additionally, gains in efficiency of power generation using natural gas and the relatively low initial investment costs of building natural gas based power generation facilities, make natural gas an attractive alternative to other fuels.

Distribution and storage of an adequate supply of natural gas are important to the establishment of power generation facilities. Because of the high volumes involved in storing of natural gas, other methods of storing and supplying natural gas have been used. The most common method of storing natural gas is in its liquid state. Liquefied natural gas (“LNG”) is produced when natural gas is cooled to a cold, colorless liquid at −160° C. (−256° F.). Storage of LNG requires much less volume for the same amount of natural gas. A number of storage tanks have been developed to store LNG. In order to use LNG as a power source, the LNG is converted to its gaseous state using a re-vaporization process. The re-vaporized LNG can then be distributed through pipelines to various end users.

One advantage of LNG is that LNG may be transported by ship to markets further than would be practical with pipelines. This technology allows customers who live or operate a long way from gas reserves to enjoy the benefits of natural gas. Importing LNG by ships has led to the establishment of LNG storage and re-vaporization facilities at on-shore locations that are close to shipping lanes. The inherent dangers of handling LNG make such on-shore facilities less desirable to inhabitants who live near the facilities. There is therefore a need to explore other locations for the storage and processing of LNG.

### SUMMARY OF THE INVENTION

A floating storage regasification unit comprising: a liquefied natural gas storage tank contained within the floating storage regasification unit; wherein the floating storage regasification unit floats in a body of water.

In an embodiment, LNG receiving, storage, and processing facilities are positioned in an offshore location. The LNG storage and processing facility, in one embodiment, is a floating storage regasification unit (“FSRU”), also referred to as a unit (“unit”). An FSRU of the invention floats in or on a body of water and/or surface of a body of water. An FSRU of the invention may at least partially extend below a surface of a body of water and may at least partially extend above a surface of a body of water. An FSRU of the invention may comprise an upper surface and a lower surface where the upper surface is above a surface of a body of water and the lower surface is below a surface of a body of water. The FSRU includes equipment for receiving, storing, and processing LNG.

In one embodiment, an FSRU of the invention is disposed in a body of water. An FSRU of the invention comprises one or more LNG storage tanks. The one or more LNG storage tanks may be contained within the FSRU. Equipment for transfer and processing of LNG may be disposed on the FSRU, generally on an upper surface of the FSRU.

In some embodiments, an FSRU of the invention may comprise a first mooring system that provides for a mooring of the FSRU at a location in a body of water. Examples of a suitable first mooring system include, but are not limited to, a yoke mooring system, a turret mooring system, and combinations thereof.

In some embodiments, an FSRU of the invention may comprise a second mooring system that provides for a mooring or docking of an LNG carrier to the FSRU. The second mooring system may comprise docking equipment on the FSRU. The second mooring system may comprise docking equipment disposed on an upper surface of the FSRU. The docking equipment may be configured to couple an LNG carrier to the FSRU. The FSRU may also provide some protection from waves while the LNG carrier is docked alongside the FSRU.

Mooring of an LNG carrier with the LNG FSRU may be accomplished using mooring lines. In an embodiment, docking equipment may be placed at a different elevation than the other LNG processing equipment. The docking equipment may be placed at an elevation to minimize the angles on mooring lines between the docking equipment and a docked LNG carrier. By placing and/or modifying the unit to have different elevations for the docking equipment and the other LNG processing equipment, the FSRU may accommodate LNG carriers directly alongside the FSRU. Additionally, fenders may be placed at various positions about the FSRU to protect the FSRU from collisions with LNG carriers. In one embodiment, fenders may be placed along a docking side of the FSRU and at corners of the FSRU. Example fenders that may be used for the mooring arrangement may be of the Yokohama (pneumatic) type with a diameter in a range of from about 4.5 meters to about 9 meters in length.

A system of ballast storage areas, also referred to as ballast cells or tanks, may be disposed throughout the FSRU. In some embodiments, liquid ballast (e.g., water), may be used to fill the ballast storage areas. The system of ballast storage areas may provide for stability and for control of draft of the FSRU during loading and unloading of LNG.

Vaporization equipment may be disposed on the FSRU. Vaporization equipment may be used to vaporize LNG to natural gas. In one embodiment, vaporization equipment includes a heat exchange vaporization system. A heat exchange vaporization system may, in some embodiments, use water from the body of water to convert LNG to natural gas. Water from the body of water may be obtained using a variety of water intake systems. The water intake systems may be configured to reduce the amount of sea life and debris that enters the heat exchange vaporization system. In some embodiments, a heat exchange vaporization system will comprise vaporizers that utilize a closed water system where water may be provided from sources other than the body of water, for example, water provided from LNG carriers, shipping vessels, and combinations thereof. For example, fresh water may be utilized instead of seawater in a closed water system. In some embodiments, the combustion units may be separated from the vaporizer units and heat may be transferred between the combustion units and vaporizer units by means of a closed loop circulation system employing a mixture of water and antifreeze. Such a closed loop circulation system may be extended to provide heating or cooling for auxiliary machinery for example air-conditioning plants, electric generator prime movers, and combinations thereof. Thus, separate water intake and outlet systems may not be needed.

The various components of LNG transfer, storage, and processing may be disposed on the FSRU, generally disposed on an upper surface of the FSRU. In one embodiment, one or more platforms may be constructed on an upper surface of the FSRU. Various LNG storage, transfer, and processing equipment may be disposed on top of platforms, rather than directly on the upper surface of the FSRU.

In some embodiments, living quarters, flare towers, and export line metering equipment may be disposed on the FSRU.

Typical LNG carriers have a net LNG capacity ranging from 125,000 cubic meters to about 165,000 cubic meters. Additionally, it is expected that LNG carriers of up to about 200,000 cubic meters, possibly about 250,000 cubic meters, in net storage capacity may be available in the future. To be able to accommodate a wide variety of LNG carriers, the LNG capacity of the FSRU may be optimized based on a number of factors. Some of the factors for determining the optimal storage capacity include the LNG capacity of one or more predetermined LNG carriers, the desired peak capacity of the FSRU for converting LNG to natural gas, the rate at which LNG from an LNG carrier is transferred to one or more LNG storage tanks, and the cost associated with operating the FSRU.

An FSRU of the invention may be constructed on-shore. After an FSRU has been constructed, the FSRU may be towed to an appropriate site and positioned at a location in a body of water. The process of building on-shore may involve excavating a hole for construction of the FSRU or use of a building facility in an established shipyard. After the FSRU is completed, the FSRU may be towed to an offshore site.

In some embodiments, at least one natural gas pipeline may be coupled to the FSRU. The pipeline may connect the FSRU to an on-shore natural gas pipeline system.

### BRIEF DESCRIPTION OF THE DRAWINGS

Advantages of the invention will become apparent to those skilled in the art with the benefit of the following detailed description of embodiments and upon reference to the accompanying drawings, in which:

FIG. 1 depicts a top view of an embodiment of an FSRU of the invention;

FIG. 2 depicts a representation of an embodiment of a vaporization process of an FSRU of the invention;

FIG. 3 depicts a representation of a closed loop system of an FSRU of the invention;

FIG. 4 depicts a cross-sectional view of an embodiment of an FSRU of the invention; and

FIG. 5 depicts a side view of an FSRU of the invention.

While the invention is susceptible to various modifications and alternative forms, specific embodiments thereof are shown by way of example in the drawings and will herein be described in detail. It should be understood that the drawings and detailed description thereto are not intended to limit the invention to the particular form disclosed, but on the contrary, the intention is to cover all modifications, equivalents, and alternatives falling within the spirit and scope of the invention as defined by the appended claims.

### DETAILED DESCRIPTION OF THE INVENTION

An offshore liquefied natural gas (“LNG”) floating storage regasification unit (“FSRU”), also referred to as unit (“unit”), of the invention may allow LNG carriers to berth directly alongside the FSRU and unload LNG. The FSRU may include one or more tanks capable of storing LNG. The FSRU may transfer LNG from the tanks to an LNG vaporization plant disposed on the FSRU. The vaporized LNG may then be distributed among one or more natural gas pipelines.

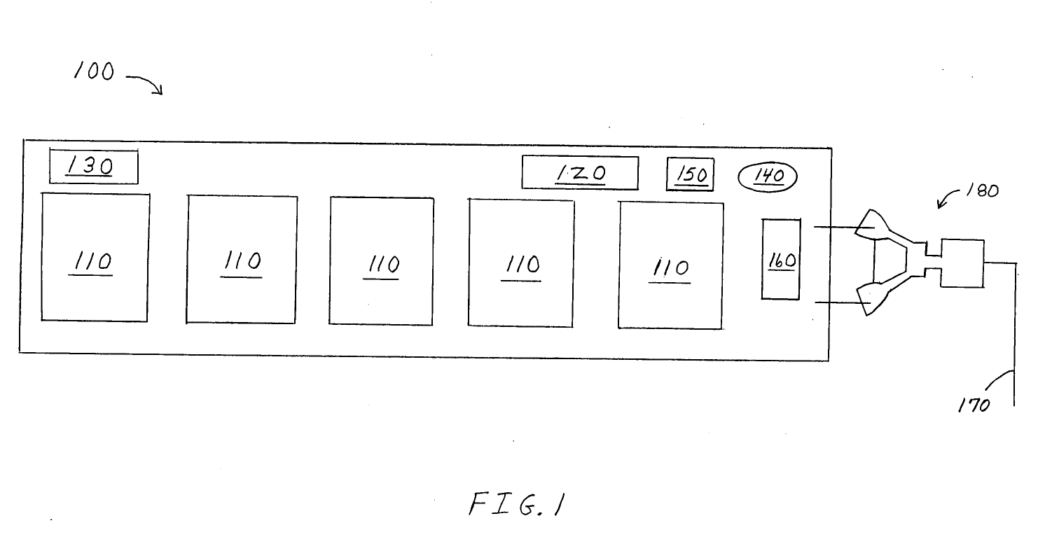

FIG. 1 depicts an embodiment of an FSRU of the invention. An FSRU 100 may have a layout that includes LNG tanks 110. The tanks may be, for example, cylindrical, square, rectangular, partially spherical, irregularly shaped, and combinations thereof. The FSRU may comprise vaporization process equipment 120 and utilities, docking equipment, living quarters 130, flares 140, vents 150, metering equipment 160, a pipeline 170 for exporting natural gas, and a first mooring system comprising a yoke mooring system 180 for mooring the FSRU at a location in a body of water. The living quarters 130, vaporization process equipment 120, and/or other process equipment may be positioned on an upper surface of the FSRU 100. In an embodiment, the layout of the FSRU may be designed to maximize safety of the living quarters.

In some embodiments, living quarters may be positioned on the FSRU. The living quarters may be positioned proximate an opposite end from the flare and/or vent. The living quarters may be positioned away from the heat exchangers and/or recondensers. In certain embodiments, living quarters on the FSRU may be positioned to be proximate living quarters on an LNG carrier during unloading. Aligning living quarters on the FSRU with living quarters on the carrier may maximize safety. The living quarters may be substantially resistant to fire, blast, smoke, etc. The living quarters may be reinforced to substantially withstand explosion overpressure. In an embodiment, the living quarters may be designed to inhibit the ingress of gas and smoke. A possible arrangement of an FSRU of the invention may comprise a recessed accommodation located at the stern with a minimum distance to the process area of about 50 meters. Having the accommodation recessed into the hull may reduce the exposure to fire and blast. Lifeboats (combined with temporary safe refuge/muster stations) may be fitted as part of the accommodation in addition to being installed in the forward area. Life rafts may also be installed in accordance with marine regulations as well as a rescue boat to respond to man overboard scenarios.

A Central Control Room (‘CCR’) may be provided inside the accommodation to enable the centralized control of, for example, loading, vaporizing, ballasting/deballasting operations, and combinations thereof.

A supply boat mooring arrangement with crane and storing area may be provided aft of the accommodation at the level of the main deck and with direct access to workshops and storerooms.

The main power generation may either be fitted on the deck or inside an aft machinery room. Compressors to supply fuel gas to the power generation, recondenser, and combinations thereof may be fitted in a deck mounted compressor room. If the main power generation is fitted inside an aft machinery room, the fuel gas line inside the machinery space to feed the dual fuel (DF) diesel generators may be installed inside a force ventilated trunk, e.g. pipe-in-pipe or pipe located inside a trunk as per IGC requirements.

The following list is an example summary of the equipment fitted on an FSRU of the invention with respect to ‘fire and gas’ and may include: fire and gas detection system, passive fire protection (for example, for accommodation, muster stations), active fire protection, fire water hydrants (ring main installed underneath the main deck), deluge (for example, for tank domes, LNG manifold area, compressor room, process area (booster pump & vaporizers), swivel stack, muster station), tug(s) with fire fighting capability, foam (hot foam and CO₂ systems), dry powder system (ring main installed underneath the main deck), portable fire extinguishers, and combinations thereof.

An FSRU of the invention may have provisions for escape, evacuation and rescue (“EE&R”). The living quarters may act as a temporary safe refuge and emergency evacuation may be by helicopter.

An FSRU of the invention may comprise a double-hull containment structure configuration. An FSRU of the invention preferably comprises a double-hull containment structure configuration. A double-hull containment structure of an FSRU of the invention may be similar to the double-hull containment structure configuration of an LNG carrier for example, a Moss-type LNG carrier, a membrane-type LNG carrier, an SPB type LNG carrier, and combinations thereof. A preferred double-hull containment structure of an FSRU of the invention is similar to a membrane-type LNG carrier. While steel is a preferred material of a double-hull containment structure of an FSRU of the invention, other materials that provide for a double-hull containment structure of an FSRU of the invention may be utilized.

The phrase “double-hull” refers to two hulls where there is an inner hull and an outer hull. An inner hull of an FSRU of the invention is the hull closest to the one or more LNG storage tanks. The inner hull is inside of the outer hull. The outer hull is the hull closest to the body of water and is generally in contact with the body of water.

It should be understood that the phrase “floating storage regasification unit” is to indicate that in general the FSRU may float and/or store LNG and/or process, for example regasify, LNG. In other words, the FSRU may simultaneously provide for floating, storing of LNG, and processing, for example regasifying, LNG, but may provide each separately. Thus, the term is not meant to be limited to having to provide for all simultaneously. For example, an FSRU of the invention, when empty of LNG, may simply float. Also for example, when processing of LNG is not being conducted, the FSRU may float and store LNG. Also for example, when the FSRU is regasifying LNG, the FSRU may float, store LNG, and process LNG.

The various components of an FSRU of the invention may be constructed simultaneously at one location or at different times at different locations and then integrated at one location for example at a shipyard or at a location in a body of water. For example, the double-hull containment structure may be constructed at one shipyard and the various components of an FSRU of the invention, for example the LNG storage tanks and related transfer and vaporization equipment could be constructed and/or prepared at a different location and then sent to the shipyard containing the double-hull containment structure for integration. Also for example, the double-hull containment structure and the various components may be transported separately to another shipyard or a location in a body of water for integration.

An FSRU of the invention may include one or more LNG storage tanks. Insulation in the tanks may be designed to limit LNG boil-off to the equivalent of approximately 0.15% of the gross LNG tank volume per day. The capacity of a tank may be up to approximately 566,000 bbl (90,000 m³) of LNG. In some embodiments, the FSRU may include greater than about 250,000 cubic meters of net LNG storage. In certain embodiments, the FSRU may include less than about 50,000 cubic meters of net LNG storage. The LNG capacity of an FSRU of the invention may be optimized based on a number of factors including LNG capacity of one or more LNG carriers, desired peak regasification capacity of the FSRU for converting LNG to natural gas, the rate at which LNG from an LNG carrier is transferred from a carrier to one or more LNG storage tanks, the need for additional buffer storage, costs associated with operating the FSRU, and combinations thereof. Currently, carriers have a capacity of about 125,000 cubic meters to about 165,000 cubic meters. Peak natural gas production may be at least about 1 billion cubic feet per day (1,960 m³/h LNG).

In some embodiments, the FSRU has a storage capacity of less than about 200,000 cubic meters of LNG. In some embodiments, the FSRU is configured to produce natural gas at a peak capacity of greater than about 1.2 billion cubic feet per day (2,400 m³/h LNG). In some embodiments, the FSRU is configured to offload LNG from carriers having a storage capacity of greater than about 200,000 cubic meters. In some embodiments, the FSRU has a length that is at least equal to a length required to provide sufficient berthing alongside the FSRU for an LNG carrier having an LNG capacity of greater than about 200,000 cubic meters.

LNG tanks may substantially store vapor and liquefied natural gas. LNG tanks may be double containment systems. LNG storage tanks may include a liquid and gas tight primary tank constructed in an interior of the FSRU. The primary tank may be formed from, for example, stainless steel, aluminum, 9%-nickel steel, and combinations thereof. The LNG containment system may be, for example, a SPB (Self-supporting Prismatic shape IMO Type “B”, for example, designed by Ishikawajima Harima Heavy Industries Co., Ltd. (IHI) (Japan)) rectangular tank system, a 9% nickel-steel cylindrical tank system, and/or a membrane tank system, for example licensed by Gaz Transport and Technigaz (France). LNG tanks may be freestanding tanks and/or self-supporting tanks. The LNG tank may be cylindrical, rectangular, partially spherical, or irregularly shaped.

In some embodiments, the tank may be a membrane tank. Membrane tanks may be commercially available from, for example, Gaz Transport and Technigaz (France).

In some embodiments, LNG storage tanks may be double containment tanks. In certain embodiments, double containment membrane tanks include a primary and a secondary barrier. The secondary barrier may ensure LNG containment in the event of a leak in the primary barrier. The insulation space between the primary and secondary barrier may be continuously monitored. A temperature of the inner hull of the double-hull containment structure of an FSRU of the invention may be monitored.

Any water ingress through the steel hull walls may cause freezing of the entrained water. Frozen water proximate the tanks may damage the containment system. Water ingress may cause damage to the polyurethane foam (PUF) insulation panels. Installation of a water detection system and a drainage pump may decrease the likelihood of freezing water proximate the tank. A temperature of hull surfaces may be regulated to substantially inhibit icing on the hull surfaces. A heating system may be provided on the walls and bottom to maintain a temperature of at least about 5° C. In some embodiments, a heating system is configured to maintain a temperature of the hull wall at or above about 5° C.

In some embodiments, regulatory authorities may require inspection of the tanks. One or more spare tanks may be installed so that a tank may be offline and the FSRU may remain operational.

Further details regarding construction of LNG storage tanks are described in U.S. Pat. No. 6,378,722 entitled “Watertight and Thermally Insulating Tank with Improved Longitudinal Solid Angles of Intersection” to Dhellemmes, which is incorporated by reference as if fully set forth herein.

In some embodiments, the LNG storage tanks may not need to be inspected during the operational life of the FSRU. The containment tanks may not need to be maintained or may require little maintenance during the operational life of the FSRU.

In an embodiment, the LNG tanks may be in service in all normal conditions during the operational life of the floating storage regasification unit. Backup storage tanks may not be provided. In some embodiments, carriers may act as backup storage. If LNG storage tanks are incapable of receiving more LNG (e.g., full tanks, failure of tanks, failure of unloading arms, etc.), an LNG carrier may store LNG until tanks are capable of receiving additional LNG. In an embodiment, if two carriers arrive at the FSRU at substantially the same time, LNG may be stored on one of the carriers until the FSRU is capable of receiving additional LNG from the carrier.

In some embodiments, drainage systems, pressure monitors and regulators, nitrogen purge systems, and/or temperature monitoring systems may be positioned between tank components. The FSRU may include back-up monitors and regulators for temperature and/or pressure. Instrumentation and monitoring systems may be provided for leak detection.

In some embodiments, LNG tanks may be equipped with automatic continuous tank level gauging, density monitoring, and density measuring. Each level indicator may have high and low alarms and will automatically stop in-tank pumps or unloading operations, as required. A temperature measurement system may be installed in the LNG tanks at various levels. Temperature of tank walls may be regulated to substantially prevent ice formation on the inner hull. Pressure transmitters may be provided in each tank to control the boil-off gas compressor, the vent system, alarms and to actuate the emergency shutdown system. Each tank may be protected against overpressure by safety valves. The tank pressure relief valves may release to atmosphere via a vent system. Natural gas from the pressure relief valves may be routed to the flare tower.

Cryogenic submerged pumps inside the tanks may transfer LNG from the storage tanks, via a re-condenser, to the suction of LNG high-pressure send-out pumps. The LNG in-tank pumps may be high-volume, low-pressure pumps, and may provide sufficient net positive suction head (NPSH) for deck mounted, high-pressure LNG pumps.

Between the inner hull of the double-hull containment structure and the outer hull of the double-hull containment structure, a grid of ballast storage areas may be used for ballasting. In some embodiments, ballast storage areas, also referred to as ballast tanks, may be disposed throughout the FSRU. In some embodiments, ballast storage areas may surround the one or more LNG storage tanks. In some embodiments, ballast storage areas may be at the forward and rear areas of an FSRU of the invention. For example, when an FSRU of the invention receives LNG from an LNG carrier, ballast may be discharged from one or more ballast storage areas. Also for example, when an FSRU of the invention regasifies LNG, liquid may be added to one or more ballast storage areas. Ballast storage areas may be used to facilitate transportation to the site, and to stabilize the FSRU at a desired location in the body of water during loading, storing, and processing of LNG. One or more ballast storage areas may be incorporated into the FSRU.

In some embodiments, under keel clearance may affect the design of the FSRU. The FSRU may be designed to maintain a specific under keel clearance in a predetermined channel. Channel depth may also affect draft of the FSRU.

The LNG storage tanks may contain vapor and liquefied natural gas. Natural gas vapor may form due to heat ingress into the storage tank. Heat may be introduced to the tank during ship unloading. Heat may enter the storage tanks from the LNG recirculation lines and by changes in the fluid composition when LNG is unloaded into the storage tanks. This vaporized LNG is typically referred to as boil-off gas (“BOG”). The normal BOG rate may be about 0.15% per day of the total storage volume.

In some embodiments, BOG may be used to regulate the pressure in the LNG carrier while unloading. BOG may be used to regulate a pressure in LNG tanks. In certain embodiments, BOG may be compressed by a BOG compressor and routed to a recondenser, also referred to as a condenser, that recondenses BOG. Examples of a suitable compressor, for example, a BOG compressor, include centrifugal compressors, reciprocating compressors, screw compressors, and combinations thereof. The recondensed BOG may mix with LNG inside the recondenser. The mixture may be routed to the gasification trains. The recondenser may be designed to process all BOG generated in the FSRU. The recondenser may be designed to process vapor from unloading carriers. In some embodiments, one or more recondensers may be coupled to one or more LNG storage tanks. The recondensers may be configured to convert natural gas to LNG. An FSRU of the invention may comprise a bypass so that compressed BOG from a BOG compressor may bypass the recondenser and be sent directly to a natural gas pipeline.

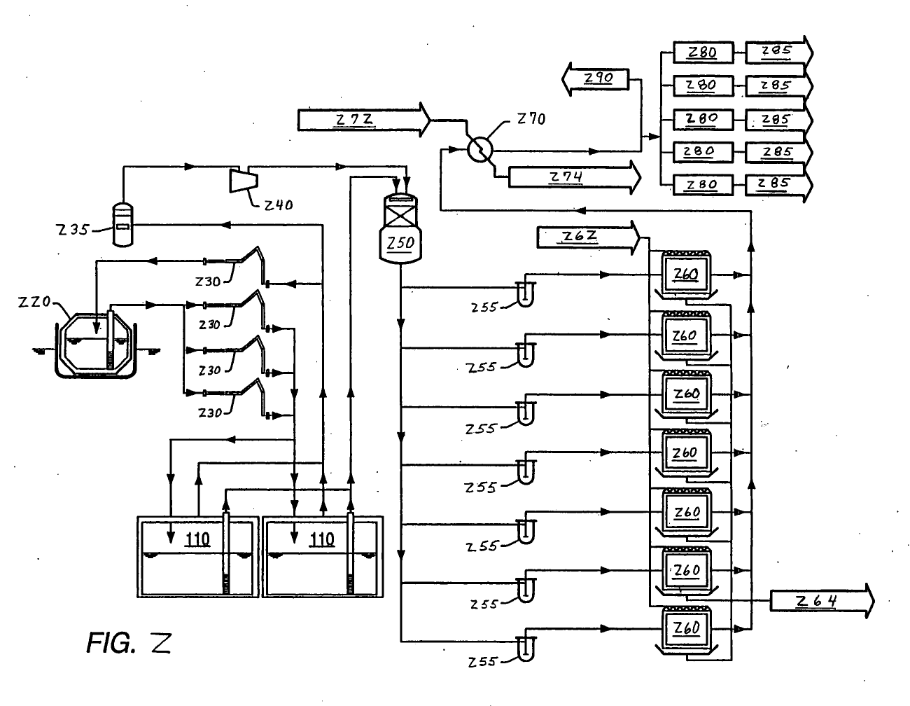

During the production of natural gas, high-pressure pumps may transfer LNG from the tanks to one or more heat exchangers, also referred to as heaters or vaporizers. LNG may be vaporized at high pressures in the heat exchangers. In some embodiments, LNG may be vaporized as schematically illustrated in FIG. 2. LNG may be pumped, utilizing low pressure pumps (not shown) that may be in storage tanks 110, to recondenser 250 and then, utilizing pumps 255, preferably high pressure pumps, the LNG may be pumped to heat exchangers 260. Examples of suitable heat exchangers 260 include open rack vaporizers (ORVs), submerged combustion vaporizers (SCVs), shell-and-tube vaporizers (STVs), intermediate fluid vaporizers (IFVs), air vaporizers, and combinations thereof. Heat exchangers 260 may have a heating medium inlet 262 and heating medium outlet 264 appropriate for the heating requirements of heat exchangers 260. LNG may be fed through aluminum tubes. While FIG. 2 discloses two storage tanks 110, it should be understood that an FSRU of the invention may have one or more storage tanks. The number of storage tanks may be any number of tanks that may be contained in an FSRU of the invention. For example, an FSRU of the invention may comprise four (4) storage tanks. Also for example, an FSRU of the invention may comprise five (5) storage tanks. Also for example, an FSRU of the invention may comprise eight (8) storage tanks.

Seawater, fresh water, and combinations thereof may be used as the heating medium for the one or more heat exchangers. The heat exchangers may use water from the body of water the FSRU is positioned in to vaporize LNG in a once-through configuration. Water lift pumps may deliver water to the heat exchangers from a water intake system. Intake screens, velocity, location, and/or orientation may be selected to minimize marine life entrainment and impingement. The water may be treated to minimize marine growth within the water intake system. A water intake and outlet system may be installed to circulate the required volume of water from the body of water, through the facilities on the floating storage regasification unit deck, and back to the body of water.

In some embodiments, heat exchangers may be designed based on regasifying LNG at peak send-out rates and minimum heat transfer rates. The heat exchanger may inhibit no more than a predetermined change in temperature of the water. The temperature drop of the water across the heat exchanger may be at least partially controlled by applicable codes. Environmental codes may regulate the temperature at which water may be released into a marine environment.

In some embodiments, a larger temperature drop across the heat exchanger may cause ice formation in the water outlet system. Smaller temperature drops across the heat exchanger for the water may be possible. In certain embodiments, warmer sea temperatures may permit a higher temperature drop across the heat exchanger and reduce the water flow rate.

Water from the water intake systems may flow to a heat exchanger vaporization system. Water may be taken into an FSRU of the invention and then flow to the heat exchanger vaporization system. Heat exchangers may be used to vaporize LNG received from LNG carriers. In some embodiments, LNG from one or more storage tanks may flow to one or more heat exchangers, also referred to as heaters or vaporizers. The vaporized natural gas may be provided to one or more commercially available pipelines coupled to the FSRU.

In some embodiments, LNG may be vaporized as schematically illustrated in FIG. 2. Heat exchangers 260 may include open rack vaporizers (ORVs), submerged combustion vaporizers (SCVs), shell-and-tube vaporizers (STVs), intermediate fluid vaporizers (IFVs), air vaporizers, and combinations thereof. When utilizing submerged combustion vaporizers, a mixture of fuel gas and combustion air (provided from a combustion air blower, not shown) may be transferred via heating medium inlet 262 to the heat exchangers 260 to vaporize LNG. Exhaust gas may then be released through heating medium outlet 264. While the overall heating medium inlet 262 and heating medium outlet 264 is shown overall, it should be understood that each individual submerged combustion vaporizer may have its own separate heating medium inlet of mixture and heating medium outlet of exhaust gas.

When utilizing open rack vaporizers, water may be transferred from a water inlet via heating medium inlet 262 to the heat exchangers 260 to vaporize LNG. Water may then be released via heating medium outlet 264 back into the body of water through a water outlet. LNG from carrier 220 may be transferred to one or more storage tanks 110 via unloading arms 230. Some LNG may vaporize during unloading from a carrier 220. Some LNG may vaporize in the storage tanks 110. The vaporized LNG from the storage tanks may be called boil-off gas (“BOG”).

When utilizing shell-and-tube vaporizers (STVs), the heating medium may be water, steam, and combinations thereof. In the case of a water system, a closed loop water and antifreeze system may be utilized by which the heated mixture comprising water and antifreeze is passed through heating medium inlet 262, circulated around the heat exchanger tubes, and then passed through heating medium outlet 264. LNG may be fed through the heat exchanger tubes. One or more shell-and-tube vaporizers may be arranged in parallel fashion as indicated in FIG. 2 and each shell-and-tube vaporizer may be supplied by a high pressure LNG pump, for example pumps 255. In the shell-and-tube vaporizer, heat is transferred to the LNG, vaporizing the LNG to natural gas and simultaneously cooling the mixture comprising water and antifreeze. The mixture may also be used to heat the gas further in one or more superheaters. The cooled mixture comprising water and antifreeze may then be returned to a machinery space for machinery cooling and. reheating via gas turbine exhaust and auxiliary gas-fired water heaters. The gas turbine and auxiliary water heater exhausts may also be fitted with one or more Selective Catalytic Reducers (SCRs) to reduce environmental emissions. When utilizing steam as the heating medium, the steam may be supplied to the vaporizers, for example, shell-and-tube vaporizers, and superheaters by remote boilers. As heat is transferred to the LNG, the steam condensate may be returned to the boilers for reheating.

Some BOG may be returned to the carrier 220 through one or more unloading arms 230. Returning BOG to the carrier 220 may be part of a vapor balance system. In addition to, or in lieu of, passing BOG to the carrier 220, BOG may also be compressed in a BOG compressor 240. The BOG may pass through a BOG compressor scrubber 235 before transfer to the BOG compressor 240. The BOG may pass through a BOG desuperheater (not shown) before entering the BOG compressor scrubber 235. Compressed BOG may be recondensed in a recondenser 250 and returned (not shown) to storage tanks 110 and/or transferred to heat exchangers 260. While not shown, in some embodiments compressed BOG and/or recondensed BOG, from the BOG desuperheater, BOG compressor scrubber 235, BOG compressor 240 and/or recondenser 250, may be transferred back to storage tanks 110 through separate drain lines and/or though valving and flow control of existing lines.

LNG may be pumped from storage tanks 110 to heat exchangers 260 to be vaporized. In some embodiments, LNG may be pumped, utilizing low pressure pumps (not shown) that may be in storage tanks 110, to recondenser 250 and then, utilizing pumps 255, preferably high pressure pumps, the LNG may be pumped to heat exchangers 260.

Vaporized LNG may be warmed in a heater 270 to inhibit hydrate formation. The heater 270 may use waste heat 272 to warm natural gas with the waste heat exiting 274. Natural gas may enter export metering lines 280. Natural gas may be distributed from the export metering lines 280 to commercially available pipelines 285 coupled to the FSRU. Some natural gas may be used as fuel 290 on the FSRU. In some embodiments, vaporization equipment may be coupled to the FSRU, preferably an upper surface of the FSRU. The vaporization equipment may be configured to vaporize the LNG to natural gas during use. While submerged combustion vaporizers utilize a water bath system, a water intake system may be configured to draw water from a body of water and supply water to the vaporization equipment.

Recondenser 250 may condense nitrogen from a nitrogen generating source (not shown), for example, nitrogen generated via membrane, cryogenic distillation, pressure swing adsorption, and combinations thereof, that may be utilized to adjust the heating value of the LNG. Also for example, nitrogen may be injected in the high pressure natural gas send-out.

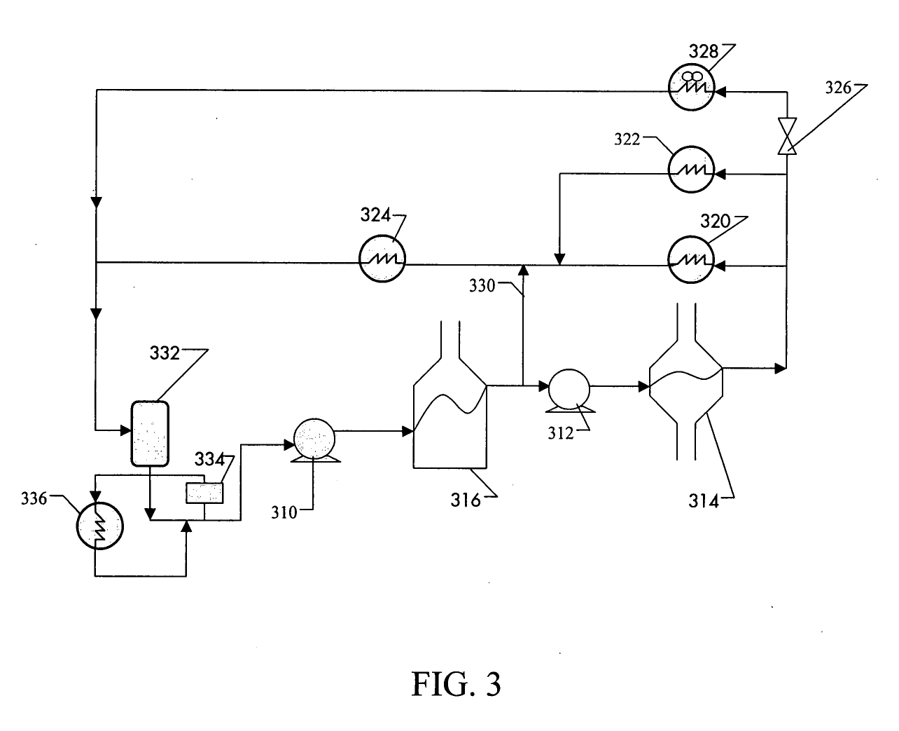

In certain embodiments, LNG may be vaporized using a heating medium comprising a mixture of water and antifreeze as described herein in a closed loop system as schematically illustrated in FIG. 3. The heating medium may be circulated using low pressure pumps 310 and 312 through a closed loop system. The heating medium may be heated by heat rejected from utility machinery 336, for example, an air conditioning plant, waste heat recovery unit 314 that may use exhaust heat from power generating gas turbines (not shown), and combinations thereof. Additional heating of the heating medium to a required temperature may be supplied by auxiliary process water heater 316 that may be gas fired.

The heating medium may then be directed to superheater 320 and vaporizer 324, for example a shell-and-tube vaporizer, for the superheating and vaporization of LNG. Heater 322 may be utilized as part of a hot water loop to heat water. Temperature control for the system may be achieved by load control of the auxiliary process water heater 316 and may also be assisted by trim cooler 328 via valve 326. Trim cooler 328 may be an air-cooled heat exchanger. Bypass 330 may be utilized to bypass certain parts of the system, for example, when a gas turbine that may supply exhaust heat to waste heat recovery unit 314 is not in use.

Surge tank 332 and filter 334 may be included to accommodate expansion in the system and to provide heating medium cleanliness. The use of a closed loop system may provide for a reduction, preferably provide for an elimination, of the need to use seawater for FSRU cooling purposes, heating purposes, and combinations thereof.

The volume percent of antifreeze in a mixture of water and antifreeze may be any volume percent that suitably provides for a mixture that may be used in a closed loop circulation system of an FSRU of the invention. Generally, the volume percent of antifreeze based on the total volume of the mixture of water and antifreeze is in a range of from about 0 volume percent, for example, when water with no antifreeze is utilized, to about 100 volume percent, for example when antifreeze with no water is utilized. Preferably, the volume percent of antifreeze based on the total volume of the mixture of water and antifreeze is in a range of from about 30 volume percent to about 70 volume percent, and more preferably in a range of from about 36 volume percent to about 60 volume percent.

Any antifreeze that provides for a mixture that may be used in a closed loop circulation system of an FSRU of the invention may be used. Examples of a suitable antifreeze that may be used include ethylene glycol, diethylene glycol, triethylene glycol, and combinations thereof.

In certain embodiments, flow controllers may regulate the natural gas send-out flow rates from the heat exchangers. Flow controllers may include a flow transmitter on the heat exchanger outlet and a control valve on the vaporizer inlet. If the gas outlet temperature or seawater exit temperature becomes excessively cold, the flow controller may be overridden. Regasification and send-out equipment may be designed for an average throughput of natural gas. In an embodiment, regasification and send-out equipment may be designed for an average throughput of about 7.7 million ton per annum (mtpa) and a peak factor of about 1.2 billion cubic feet per day (2,400 m³/h LNG).

The LNG FSRU may be designed to permit a rapid start-up of the heat exchangers. Maintaining a small flow of LNG through a heat exchanger on standby may permit rapid start-ups. The use of thermal expansion joints that allow rapid cool down of the LNG inlet line may permit rapid start-ups. In an embodiment, a FSRU may have one or more spare heat exchangers, such that spare heat exchangers may be used during maintenance and/or repair of other heat exchangers.

In an embodiment, the FSRU may be designed such that the peak regasification rate is expandable. The FSRU may allow offloading from a range of LNG carrier sizes. The carriers may unload their cargo at cryogenic temperatures into the storage tanks contained within the FSRU. The FSRU may be designed to process a range of LNG compositions ranging from rich to lean. Custody transfer metering may occur on the FSRU prior to export into the pipeline network.

Natural gas exiting the heat exchangers may be metered into one or more pipelines and flow to one or more pipeline tie-in locations onshore. The reduction in pressure along the pipelines may produce a cooling effect. The cooling effect may only be partly compensated by heat ingress from the surrounding seawater. The send-out gas may be heated in order to mitigate the possibility of hydrate formation in the takeaway pipelines. A spare sales gas heater may be installed to heat the send out gas. In an embodiment, demineralized hot water may heat send-out gas. The natural gas stream may be divided between the pipelines connected to the FSRU. In an embodiment, each pipeline may have its own pressure reduction station and custody transfer meter, for example, an ultrasonic custody transfer meter, to accommodate the export flow rate. The gas from all the heat exchangers may be combined in one or more common sales gas headers.

In some embodiments, the gas may be routed from the sales gas header to one or more superheaters. A spare superheater may be installed on the FSRU. In an embodiment, the superheaters may be of printed circuit type (PCHE). PCHE superheaters may be compact and/or stacked, as required. The superheaters may use tempered water from waste heat recovery units to warm natural gas. The superheaters may direct warm natural gas into one or more common sendout headers. The warmed send-out gas may then be metered to subsea export pipelines. The send-out gas may experience a pressure drop across the metering lines.

In some embodiments, natural gas may be heated by a tempered water system. Waste heat from a gas turbine power plant on the FSRU may be utilized as the primary heating source for the tempered water system. The waste heat recovery system may be able to discharge a surplus of waste heat as well as additionally heating within its operation window. A configuration using gas turbines with waste heat recovery units, equipped with a controlled flue gas by-pass system may assist the waste heat recovery system meet its output requirements. With this system the heat added to the tempered water system may be controlled by partial by-pass of the gas turbine flue gasses directly to the stack. In an embodiment, a tempered water system may be equipped with a gas fired auxiliary water heater to add heat to the system in case waste heat capacity of the power plant(s) is not sufficient.

Natural gas may be exported from the FSRU to markets for sale and/or further processing. The export gas may be distributed among the one or more pipelines in varying quantities. An FSRU of the invention may be configured such that additional pipelines may be coupled to the FSRU at a later date. Flow controllers may operate each send-out pipeline. Each pipeline may be coupled to a metering station comprising a metering run. An example metering unit comprises an ultrasonic custody transfer type. In an embodiment, one common spare metering unit may be available for calibration purposes.

The number of metering runs required for each station may be determined by the maximum required export rate and the maximum permitted flow velocity through the metering run. Online analysis of the exported gas may be undertaken at the sales gas header.

In some embodiments, the FSRU may include facilities for on-site generation of sodium hypochlorite from seawater via electrolysis. The unit may be designed to allow continuous dosing by adding sodium hypochlorite into the system. The FSRU may include hydrogen degassing tanks, air blowers to vent hydrogen gas to a safe location, storage facilities, and/or sodium hypochlorite injection pumps. In an embodiment, the FSRU may produce nitrogen on board.

Fresh water may be needed on the FSRU. The FSRU may have water inlet lift pumps that supply seawater for the fresh and potable water systems. The seawater may enter the lift pumps through a water intake system. Seawater may be strained through self-cleaning strainers. The pumps may feed an electro-chlorination unit and a desalination package. The desalination unit may include reverse osmosis units to produce fresh water from seawater. Fresh water may be stored in fresh water storage tanks. Potable water may be made from fresh water by a demineralization package. Potable water may be stored in potable water tanks. The potable water may be distributed on demand. Potable water systems may at least meet the World Health Organization's standard for potable water. The system may be designed to prevent contamination of the potable water system by using a break tank to prevent contamination of the potable water system from non-sterilized sources. Water in the line may be replenished with newly sterilized water by flushing connections and/or long runs of piping.

In some embodiments, a FSRU may include a relief system. The relief system may include relief headers, lit flare headers, and/or emergency vent headers (low pressure and high pressure vents). Flare headers connected to the tank vapor space, balance line, and/or depressuring lines may operate during tank cool down and overpressure scenarios. In an embodiment, a self-igniting flare may be provided to safely dispose of emergency hydrocarbon releases. A majority of the process relief valves may be routed to the flare. The flare system may detect a release of emissions and self-ignite when required. The ignitable flare concept may minimize the overall greenhouse gas emissions to the atmosphere by the flare. In an embodiment, under normal operating conditions, the flare system may rarely flare. BOG may be recondensed to LNG and routed to high-pressure LNG pumps. The vent stack may be located on the FSRU. Vents may be connected to the atmosphere. An emergency vent header may include tank pressure relief valves. The vent stack may be designed to accommodate all relief loads from the tank and/or may be used during flare maintenance.

In certain embodiments, a flare system may be used to limit pressure within the tanks. The low-pressure BOG header may be connected to the flare system via a pressure control valve to relieve excessive pressures. A flare header may collect vapors from most of the process equipment relief valves and depressuring valves via a high-pressure system. The flare may be retractable. A retractable flare may allow dismantling of the stack for flare tip maintenance. Hydrocarbon emissions may be temporarily directed to the vent stack during flare maintenance, severe tank rollover, and/or if the flare is offline. In an embodiment, hydrocarbon relief is normally routed to a closed relief system for disposal to a self-igniting flare. The vent and flare stacks may be located proximate each other. The flare may be located proximate a corner of the FSRU. In an embodiment, the vent and flare stacks may have similar heights to prevent damage from accidental ignition.

In some embodiments, a vent system may be used as a discharge for the storage tank pressure sensitive valves. Due to the nature of the FSRU, and the confined environment, the tank pressure sensitive valves may be sized to accommodate various foreseen relief loads (e.g., rollover) from the storage tanks. The pressure sensitive valves may discharge into the vent header to permit dispersion.

Thermal safety valves may flow to the vapor balance header in order to minimize the fugitive emissions from the FSRU. The flow rate of the thermally safety valves may be small enough to be accommodated by the storage tank and BOG compressor systems.

In the event of a prolonged shutdown, the pressure within the storage tanks may increase and BOG may need to be flared. The tank overpressure relief valves may discharge directly to the vent stack. The vent stack may be designed to accommodate all expected relief loads from the storage tanks, including rollover.

The relief valves from the heat exchangers may be collected into a common high-pressure relief header for further direction to a relief system. Thermal relief valves may relieve back to the vapor balance line. Pressure safety valves may be connected to the flare relief header. Vaporizer pressure relief valves may discharge directly into the atmosphere.

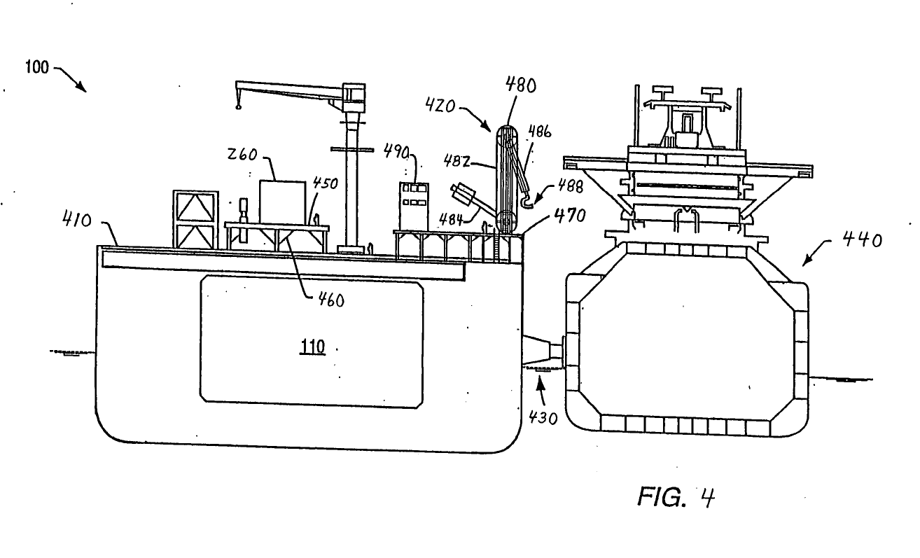

An offshore FSRU of the invention may accommodate LNG storage tanks, allow LNG vaporization plant and other process equipment and utilities to be positioned on an upper surface of the FSRU, and safely enable LNG carriers to berth directly alongside the FSRU. An embodiment of the FSRU is depicted in FIG. 4. The FSRU 100 may include an upper surface 410 with LNG transfer equipment 420. Second mooring system comprising mooring equipment 430 may couple a liquefied natural gas carrier 440 with the FSRU 100. The FSRU 100 may allow a carrier 440 to dock on one or more sides of the FSRU. In an embodiment, the second mooring system comprising mooring equipment 430 may be positioned on both lateral sides of the FSRU 100. A “buffer belt” around a periphery of the FSRU may provide protection against carrier impact.

The top level of the FSRU 100 may be determined by structural stiffness requirements and consideration of the LNG tank 110 dimensions. Topsides 450 of the FSRU. 100 may be constructed and/or integrated in a dry dock prior to positioning the FSRU in a body of water. In an embodiment, the FSRU topsides 450 may be elevated on about 5 meter high steel module support frames 460. FSRU topsides 450 may be elevated for ease of construction. Elevating the topsides 450 of the FSRU 100 may also allow water to run over the deck 410 under severe weather conditions without substantially submerging equipment, for example heat exchangers 260 and LNG transfer equipment 420, on the topsides.

A first mooring system comprising an external turret system may be a preferred option for a typical water depth of greater than 30 meters. An external turret may be preferable to a Yoke Mooring System but may be dependent on water depth and may require a complete riser design as part of the concept selection. A double hump riser configuration may be a feasible arrangement.

A first mooring system of an FSRU of the invention may be a weathervaning arrangement to obtain a sufficiently high connecting threshold for the berthing operations of an LNG carrier. A first mooring system and high pressure gas export line may be located at the forward end of an FSRU of the invention.

After selection of the location of an FSRU of the invention, an assessment should be made of the technical feasibility of a first mooring system comprising, for example, an external turret system, an internal turret system, a Yoke Mooring System (YMS), and combinations thereof. An example YMS comprises, for example: a jacket (the jacket may comprise a four legged tubular structure that may be fixed to the seabed via one or more, generally four, piles, driven through the corner tubulars), a mooring head (a mooring head may be located on top of the jacket and may be free to rotate; the mooring head may support the pipe work and equipment, including the swivel stack), a yoke (a yoke may be a tubular triangular frame that may be connected to the mooring head via a roll and pitch articulation; permanent ballast tanks may be a part of the yoke structure to provide the required pretension in the mooring legs), mooring legs (the mooring legs may comprise tubular steel members connected to the adjacent structure via uni-joints; an axial thrust bearing may also be included to provide rotational freedom; the mooring legs with the yoke weight suspended underneath may provide the pendulum mechanism of the mooring system), a mooring structure on the FSRU (a mooring structure on the FSRU may comprise a tubular frame mounted onto the bow of the FSRU; the structure may overhang the bow of the vessel to provide clearance for the yoke; lifting means may be provided for handling of one or more jumper hoses), gas transfer may be performed via one or more, generally two, 16″ flexible jumper hoses that may provide a 2×100% capacity.

A first mooring system comprising a YMS may include a gas swivel to transfer send-out gas from the weathervaning FSRU to a fixed pipeline riser. An in-line swivel may be expected to provide sufficient reliability (typical MTTF of 20 Years) but an ‘N+1’ arrangement of the fluid transfer system may be obtained through additional toroidal swivel modules. The in-line swivel may be used for operation; the toroidal module may provide the back-up. In case of failure, the in-line may be changed out while the send-out gas may be routed through the toroidal swivel path.

An FSRU of the invention may be designed to accommodate severe weather conditions for example hurricanes, tropical depressions, tsunamis, tidal waves, and/or electrical storms. During severe weather conditions, large waves may impact the FSRU and green water may flow over a deck of the FSRU. At least about one meter of water on a horizontal face of the FSRU may be classified as “green water.” The FSRU may additionally include steel modules that raise the topsides equipment above the deck level. Modules may be positioned at a height above the deck to reduce damage from overtopping waves and/or green water.

In some embodiments, the height of the upper surface, on which mooring equipment, for example, quick-release hooks (QRHs) are disposed, above the surface of the body of water may be such that an angle of mooring lines extending from the mooring equipment to the liquefied natural gas carrier coupled to the body is less than about 30 degrees.

Mooring lines may lead directly from the carrier fairleads to the mooring hooks on the FSRU. In an embodiment, mooring line load forces may be kept below about 55% of the Minimum Breaking Load. Increasing mooring line length by leading lines through fairleads on the FSRU to remote Quick Release Hooks (QRH) may cause chafing. In some embodiments, mooring line flexibility may be in a nylon tail pennant.

A mooring line length of at least about 15 meters between the outermost compressed fender line and the QRH may ensure the nylon pennant and joining shackle are clear of the ship's fairlead and not subjected to chafing. In an embodiment, the minimum safe working load of each mooring hook may be more than the minimum-breaking load of the strongest mooring line anticipated. In some embodiments, the operational mooring line may not exceed the greater of 2.5 times the winch brake holding capacity or 2500 KN. The extreme mooring load may not exceed the greater of 2.5 times the minimum breaking load line or 3125 KN. The capstan barrel may be at a suitable height to permit safe handling of messenger lines. The QRH-assembly may be electrically isolated from the platform decks. The insulation may provide an electrical resistance of at least about 1 mega-Ohm.

QRHs may be positioned on the FSRU. The mooring lines may lead directly from the vessel fairleads to the QRHs on the FSRU. Decks may have rounded edges in front of the mooring hooks to prevent chafing of the mooring lines.

In some embodiments, the number of fenders used on a FSRU may be the number sufficient to substantially avoid contact between the carrier and the FSRU. In some embodiments, one or more fenders may be positioned about a perimeter of the body. In some embodiments, one or more fenders may be configured to absorb a substantial portion of a load from a carrier colliding with the fender.

Monitoring systems may be in place at the berth to detect vessel speed of approach carriers; mooring line loads through strain gauges on QRHs; and/or pressure monitoring system in air block fenders. Data from the monitoring systems may be centrally collected and displayed in a control room.

The centerline of the unloading arms may be positioned to create a maximum degree of protection for all types of common LNG carriers.

FSRU 100 may include an unloading platform 470, depicted in FIG. 4. The unloading platform 470 elevation may be at a predetermined height above a top surface of the body of water. An edge of the platform may protrude over the side of the FSRU. The unloading platform 470 may support LNG transfer equipment 420. The LNG transfer equipment 420 may offload LNG from an LNG carrier 440.

The LNG transfer equipment 420 may include unloading arms 480, also referred to as loading arms. Unloading arms may be Chiksan unloading arms available from FMC Energy Systems. The LNG transfer equipment may include power packs, controls, piping and piping manifolds, protection for the piping from mechanical damage, ship/shore access gangway with an operation cubicle, gas detection, fire detection, telecommunications capabilities, space for maintenance, Emergency Release Systems (ERS), Quick Connect/Disconnect Couplers (QCDC), monitoring systems, and/or drainage systems.

In some embodiments, LNG may be transferred from an LNG carrier to the LNG storage tanks by means of one or more unloading arms, for example, swivel joint unloading arms. The unloading arms may be used for unloading the LNG. One or more unloading arms may be used for returning vapor displaced in the storage tanks back to an LNG carrier. In an embodiment, unloading arms may be used for either liquid or vapor service, as required, allowing maintenance of any of the unloading arms. Between unloading operations, the unloading system may be kept cold by re-circulation of a small quantity of LNG.

The LNG unloading arms 480, depicted in FIG. 4, may include a fixed vertical riser 482 and two mobile sections, the inboard arm 484 and the outboard arm 486. A flange 488 for connection to carrier 440 may be positioned proximate an end of the outboard arm 486. Swivel joints may enable the arms and the connecting flange to move freely in all directions. The length of the unloading arm may be designed to accommodate different LNG carrier sizes. Unloading arm length may accommodate the elevation change between a fully laden and an empty LNG carrier, the movement of the ship due to tides and longitudinal and transfer drift, the elevation of the FSRU, and combinations thereof. Unloading arms may be located proximate a center of the FSRU. In some embodiments, there may be one or more fixed vertical risers and mobile sections depending on the number of LNG unloading arms.

Unloading arms may be equipped with an emergency release system. When the connecting flange reaches the limit of its operating envelope, an alarm may sound, the cargo pumps may shut down, and the unloading arm valves may close. Automatic disconnection of the unloading arms from the ship manifold may then occur. The arms will normally be operated from a control panel in a cabinet or control room located on the FSRU (see 490 in FIG. 4) proximate the arms.

Commonly available, traditional, hard unloading arms may be used. The maximum allowable pressure drop and the liquid velocity restrictions related to unloading arm vibration and cavitation may determine a minimum unloading arm diameter. The number of unloading arms positioned on the FSRU may be the number necessary to provide a desired maximum liquid loading rate. A vapor return unloading arm may be used to return BOG to the carrier during unloading. An extra unloading arm may be positioned on the FSRU for use as an unloading arm or a vapor return for ease of maintenance and/or repair. In an embodiment, an unloading rate may be reduced to approximately 50% to 60% of the design capacity when one or more unloading arms are being repaired or replaced. In some embodiments, the LNG may be recirculated through unloading arms to regulate temperature when the unloading arms are not in operation. When unloading is substantially complete, nitrogen gas may be used to force LNG from the unloading arms back into the carrier and into the storage tanks via drain lines. In an embodiment, a piping layout may be sloped to allow LNG to drain into the storage tanks without the use of a drain drum.

Although a three-unloading arm concept may be technically acceptable, a four-unloading arm concept may have more redundancy. Redundancy may increase the integrity and/or reliability level. The spare unloading arm may be used on a day-to-day basis. This may safeguard the proper functioning of the equipment. The installation of one or more spare unloading arms may increase the normal overall LNG loading capacity.

The design of the FSRU may account for severe weather conditions. To decrease the environmental impact on the slender and flexible unloading arms, the unloading arms may be put in “hurricane resting position” when hurricane conditions are expected. In hurricane resting position, the unloading arm riser may remain vertical but the inner and outer arm will be tied-back horizontally. In some embodiments, a support frame may be positioned behind unloading arms, to secure the horizontal part of the unloading arm by an extra fixation point. In some embodiments, at least a portion of the unloading arms may be positioned in a substantially horizontal position during storage of the unloading arms.

Transfer of LNG from an LNG carrier to an FSRU of the invention may be based on traditional hard arms, which are currently used at onshore terminals for ship-shore LNG transfers. To enable safe and reliable connecting and disconnecting under seaway motions, for ship-to-ship loading, a guide-wire system may be utilized to guide the loading arm to the ship manifold.

The tank operating pressure during the unloading operation may rise to minimize vapor generation due to heat ingress. The vapor displaced during the unloading process may be returned to the LNG carrier using the pressure differential between the storage tanks and the carrier. In some embodiments, a return gas blower may not be required due to the short tank-to-carrier distance.

The unloading pipework may slope continuously down to the tanks. In an embodiment, the unloading piping system may continuously slope down to at least one tank. Sloping the pipelines towards the tanks may eliminate a need for a ‘Jetty’ drain drum and associated lines. In an embodiment, a Jetty drain drum may be utilized. Pressure control may be used to maintain the LNG unloading line under pressure and to control the unloading flow. Regulation of the pressure may be necessary to prevent tank overpressure and/or vibration within the unloading line.

In some embodiments, a significant topside inventory of LNG on the FSRU may be held in the recondenser vessel and pump suction header. The recondenser and HP pump suction header may remain liquid-full during normal plant operation. In the event of zero sendout from the FSRU (e.g. hurricane scenario), the recondenser vessel and the header may remain liquid full to allow the line to remain at cryogenic temperatures. In the event of an emergency situation, (e.g. direct hurricane impact on FSRU or fire on the FSRU), an emergency function to drain the recondenser and suction line may be provided. Drainage of the system may be by gravity flow back into the tank underneath the recondenser. Residual pressure within the system may at least partially assist the gravity flow back to the tanks. After drainage, the remaining LNG inventory within the process equipment may be insignificant.

The FSRU may include one or more emergency safety systems. In an embodiment, emergency safety systems may be designed to comply with acceptable industry codes. During operation of the emergency system, several FSRU operations may be shut down. The LNG unloading operation may cease in a quick, safe, and controlled manner by closing the isolation valves on the unloading and tank fill lines and stopping the cargo pumps of the LNG carrier. The emergency operations may be controlled on the LNG carrier or from the FSRU via a ship-to-FSRU interface. Emergency controls may be manual (e.g., buttons in strategic locations), automatically (via the appropriate alarms signals received from the transfer facilities), or by rupture of the ship-to-shore link. Emergency systems may be designed to allow LNG transfer to be restarted with minimum delay after corrective action has been taken.

The second stage emergency shutdown system may activate the unloading arm emergency release system (ERS) and cause the unloading arms to disconnect from the ship. “Dry break” uncoupling may be achieved by ensuring the closure of two isolation valves, one directly upstream and one directly downstream of the emergency release coupler prior to the uncoupling action. In some embodiments, unloading arm uncoupling may occur as quickly as possible. As the piping systems for the LNG carrier and the FSRU are relatively short, loading arm ERS valve closure times of 5 seconds may not give rise to surge pressures exceeding the design pressure of the piping systems.

The export shutdown may be activated by manual initiation. The emergency system may stop and isolate all pumps and compressors, isolate the heat exchangers and superheaters, and/or close various valves. Activation of the export shutdown, ERS, may stop and isolate the gas export equipment in a safe, sequential manner. The emergency system may initiate draining of the LP pump send-out header, recondenser, and HP pump suction header back into the storage tanks to minimize the inventory of LNG above deck level.

While keeping the FSRU at approximately its final location, the FSRU may be moored to a first mooring system, for example, a yoke mooring system, an external turret system, an internal turret system, and combinations thereof. In an embodiment, liquid, for example water, is placed in ballasts to stabilize the FSRU. In some embodiments, liquid-, for example water-, ballasting operations may continue until stabilization is achieved. In some embodiments, the FSRU may be considered ‘storm-safe’ for the design hurricane after liquid, for example water, ballasting.

In certain embodiments, it may be desirable to decommission an FSRU of the invention. In an embodiment, an FSRU of the invention may be reused. At the end of an operating life of an FSRU of the invention, the FSRU may be removed from the site to be reused or completely decommissioned. The equipment on the FSRU may be decommissioned prior to removal of the FSRU. Upon decommissioning, the FSRU may be towed to a desired onshore location. In an embodiment, the FSRU may be floated to a different offshore location.

In some embodiments, decommissioning may include performing the marine installation in reverse. A body of water may be surveyed after towing the FSRU from the site. The body of water may be cleaned after removal of the FSRU from the site.

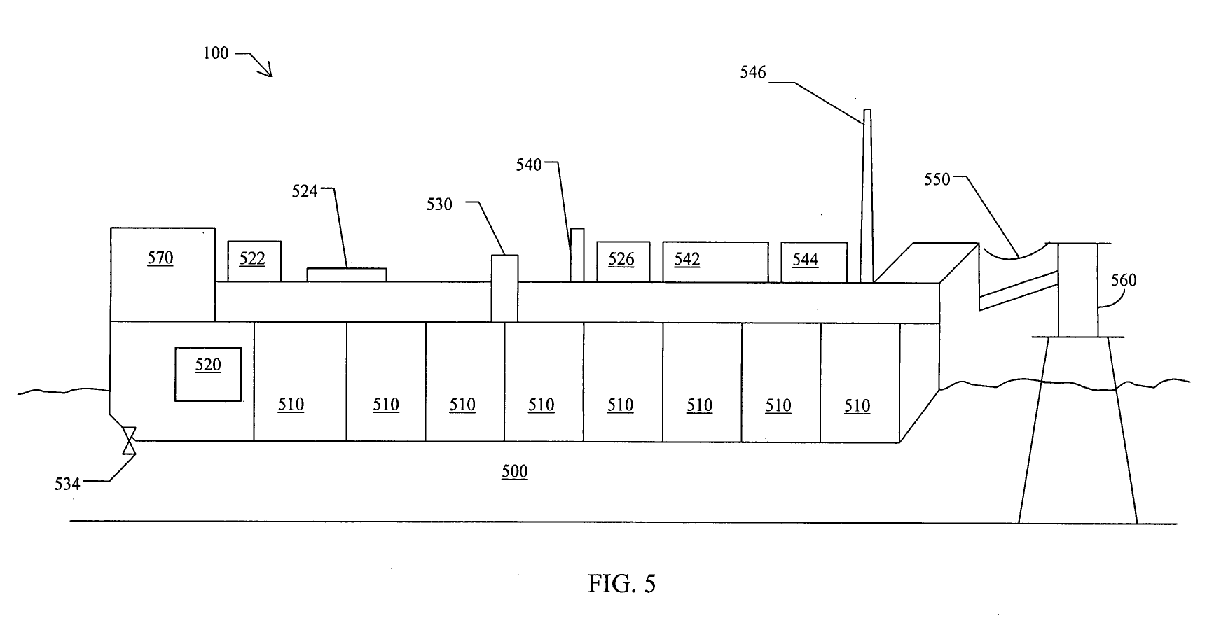

FIG. 5 depicts another embodiment of an FSRU of the invention. FSRU 100 on a body of water 500 may comprise a layout that comprises LNG tanks 510. FSRU 100 may comprise utility equipment comprising gas turbine power generation 522, thrusters 534 that may assist the positioning of FSRU 100, and accommodation area 570. FSRU 100 may comprise LNG handling and vaporization process equipment comprising loading arms 530, boil off gas compressors 526, process heaters 520 that may be located in the hull of FSRU 100, recondenser 540, high pressure pumps and vaporizers 542, superheaters 544, and flare 546. Nitrogen generation plant 524 may be provided to adjust the heating value of the send-out gas. FSRU 100 may be connected to a Yoke Mooring System 560 by which gas send-out may be conveyed to a subsea pipeline (not shown) by flexible jumpers 550.

A length of an FSRU of the invention may be any length that provides for an FSRU that provides for storing and/or processing of LNG as described herein and is generally at least about 100 meters, specifically at least about 200 meters, more specifically at least about 300 meters, and generally no more than about 1000 meters, specifically no more than about 750 meters, and more specifically no more than about 500 meters.

A breadth of an FSRU of the invention may be any breadth that provides for an FSRU that provides for storing and/or processing of LNG as described herein and is generally at least about 20 meters, specifically at least about 30 meters, more specifically at least about 40 meters, and generally no more than about 300 meters, specifically no more than about 200 meters, and more specifically no more than about 100 meters.

A draft of an FSRU of the invention may be any draft that provides for an FSRU that provides for storing and/or processing of LNG as described herein and is generally at least about 5 meters, specifically at least about 7 meters, more specifically at least about 10 meters, and generally no more than about 25 meters, specifically no more than about 20 meters, and more specifically no more than about 15 meters.

A length:depth ratio of an FSRU of the invention may be any length:depth ratio that provides for an FSRU that provides for storing and/or processing of LNG as described herein and is generally at least about 5, specifically at least about 7, more specifically at least about 10, and generally no more than about 20, specifically no more than about 18, and more specifically no more than about 15.

A general arrangement of an FSRU of the invention may be to accommodate, for example: FSRU first mooring system, regasification plant (divided into, for example, vaporizers and booster pumps), BOG compressors and recondenser, flare stack, nitrogen injection plant, power generation, utilities, LNG storage, berthing and second mooring system facilities for the LNG carrier, accommodation/Heli-deck/Supply boat mooring, and combinations thereof.

An LNG carrier may be either operated in a fully loaded condition or near empty condition. An FSRU of the invention potentially operates at all levels from full to empty as the LNG may be received in parcels and constantly being vaporized. Ship motions in combination with a partially loaded condition may result in a phenomenon called “sloshing”. Sloshing may be a consideration with “membrane” type tanks and may not be an issue for an “SPB” type tank because the liquid motion may be suppressed through installation of wash bulkheads.

An example first mooring system of an FSRU of the invention may be a Yoke Mooring System (“YMS”), because the water depth for an inshore location may be in a range of from about 15 meters to about 30 meters and may not allow for the catenary of an external turret system. Maximum sea states should be obtained to ensure that the first mooring system utilized can meet such maximum sea states.

Examples of suitable means of electric power generation include: gas turbines, dual fuel-diesel engine (running on BOG with about 1% diesel fuel), and combinations thereof, preferably gas turbines. If gas turbines are utilized, at least one of the gas turbines may have dual fuel capability.

Functional requirements for an FSRU of the invention may include heating value adjustment which may be achieved through a nitrogen injection system. Nitrogen may be injected upstream or downstream of a vaporizer outlet. A nitrogen injection system may also be used for the purposes of inerting, for example, tank barrier spaces, gas lines, LNG transfer lines, cargo, and combinations thereof.

An FSRU of the invention may additionally include: an emergency diesel generator, distilled and domestic fresh water, fresh water cooling for machinery, sea water cooling, lubricating oil system, fuel system, machinery bilge system, instrument and plant air, and combinations thereof. The sparing philosophy for main equipment is to have ‘N+1’ to allow inspection/maintenance on individual units.

An FSRU of the invention may be considered to be an Offshore Installation and may operate within the territorial waters of a Coastal State. The design, construction, and operation of an FSRU of the invention may need to meet the standards and codes generally applicable to an FSRU and its location, for example, the standards of a Coastal State Authority. The application of such standards may be delegated by the Coastal State to a Classification Society. For example, an FSRU of the invention may need to comply with the requirements of the Federal Energy Regulatory Commission (‘FERC’), the US Coast Guard, and combinations thereof. For example, an FSRU of the invention may need to be Classed with a Classification Society and may need to comply with relevant codes and regulations.

For example, an FSRU of the invention, including its hull, machinery, equipment, outfittings, and combinations thereof, may be constructed in accordance with the Rules and Regulations of Lloyds Register of Shipping (‘LR’) and under special survey of a Classification Society's surveyors. Alternatively, another International Association of Classification Societies (IACS) member having equivalent LNG and offshore experience and knowledge of the Coastal State requirements may be proposed.

Codes related to onshore LNG terminals may also be included where appropriate.

A Yoke Mooring System (“YMS”) of an FSRU of the invention may be classed as part of the Classification process for an FSRU of the invention in accordance with rules and regulations for a Classification of A Floating Offshore Installation at a Fixed Location.

A possible heat exchanger arrangement may include a combination of SCVs for use in the winter and ORVs for use in the summer. Example options include Option 1, Use all SCV's—Option 2, Use ORVs with seawater preheat system for winter months—Option 3, Use ORVs for the summer to provide 100% send-out and use SCV's for the winter and for peak shaving. Additional onshore heating may be required to meet custody transfer requirements.

An example approach procedure of an LNG carrier to an FSRU of the invention may include: about 12 hours before the estimated time of arrival (“ETA”), prevailing weather conditions and status of both FSRU and LNG carrier are exchanged; preparations are made, for example testing of LNG arms, mooring equipment, fenders and selecting LNG carrier approach, about 1 hour before ETA, the LNG carrier will arrive at the agreed entry point, at some 2 to 3 nautical miles from the FSRU and with a forward speed, typically 4 knots; berthing master will board and tugs are ready to be connected, the LNG carrier will head for a position off the starboard side of the FSRU and target to come to complete stop near parallel to the FSRU, at approximately 100 m separation, the LNG carrier will move side-ways, whilst monitoring the applied thruster/tug forces, heading relative to the FSRU and approach velocity; if control over the LNG carrier position and heading becomes difficult, the approach will have to be aborted, and pneumatic equipment may be used from the FSRU to shoot across messenger lines. It may be expected that mooring lines will be passed after touching the fenders.

Currently, the significant wave height limit (Hs) for berthing of an LNG carrier alongside an FSRU of the invention may be considered to be in the range of from about 1.8 to about 2.0 meters, and in the range of from about 2.0 to about 2.5 meters for being moored alongside an FSRU of the invention.

An example departure maneuver looks very much a mirror image of the example approach process. At the start of the actual departure, the ESD link systems is disconnected, with radio links maintaining the integrated systems needed for a safe departure. The LNG carrier prepares to start the departure maneuver. Then the mooring lines are disconnected, which may be implemented one by one, depending on prevailing weather conditions and final operating procedures.

An example departure maneuver may see the LNG carrier moving the bow clear from the FSRU using tugs or carrier bow thruster in combination with wind/wave/current conditions. When the hulls are clear of each other the LNG carrier will use its main propulsion system to move clear and tugs will disconnect.

An LNG carrier may be moored in the furthest forward and aft positions. Mooring hooks may be located well in-board to provide sufficient length for the deployed mooring wires and obtain a terminal arrangement with breast lines, spring lines, and combinations thereof.

Quick Release Hooks (‘QRHs’) may be fitted with a capstan (dolly winch) for rope handling and a load monitoring system connected to the central control room to monitor mooring line loads. A mooring analysis program in the CCR may be installed to allow the verification of specific mooring arrangements.

Offshore installation work for an FSRU of the invention may include: installation of mooring platform, hook-up of the FSRU to the mooring platform, and installation of jumper hoses. These activities may be performed as separate activities or can be combined into a single continuous activity. It may be preferable for schedule contingency purposes that the mooring platform be installed prior to arrival of an FSRU of the invention at a location in a body of water.

Other offshore installation work may relate to the one or more tie-ins to the one or more gas export pipelines via one or more subsea tie-ins. Pipeline work may be linked with the FSRU installation work that may provide for a reduction in cost related to mobilization of installation vessels and may also provide flexibility with respect to performing various installing activities.

What is claimed is:

1. A floating storage regasification unit comprising:
a liquefied natural gas storage tank contained within the floating storage regasification unit;
wherein the floating storage regasification unit floats in a body of water.

2. The floating storage regasification unit of claim 1, further comprising a first mooring system, wherein the first mooring system is configured to moor the floating storage regasification unit at a location in the body of water.

3. The floating storage regasification unit of claim 1, further comprising liquefied natural gas transfer equipment, wherein the liquefied natural gas transfer equipment is configured to transfer liquefied natural gas from a liquefied natural gas carrier to the liquefied natural gas storage tank.

4. The floating storage regasification unit of claim 1, further comprising vaporization equipment, wherein the vaporization equipment is configured to vaporize liquefied natural gas to natural gas.

5. The floating storage regasification unit of claim 1, further comprising a second mooring system, wherein the second mooring system is configured to moor a liquefied natural gas carrier to the floating storage regasification unit.

6. The floating storage regasification unit of claim 1, further comprising a first mooring system, wherein the first mooring system is configured to moor the floating storage regasification unit at a location in the body of water, and wherein the first mooring system is selected from the group consisting of external turret mooring systems, internal turret mooring systems, yoke mooring systems, and combinations thereof.

7. The floating storage regasification unit of claim 1, further comprising a first mooring system, wherein the first mooring system is configured to moor the floating storage regasification unit at a location in the body of water, wherein the first mooring system comprises a yoke mooring system.

8. The floating storage regasification unit of claim 1, further comprising a closed loop system.

9. The floating storage regasification unit of claim 1, further comprising a closed loop system comprising a shell-and-tube vaporizer.

10. The floating storage regasification unit of claim 1, further comprising a closed loop system comprising a shell-and-tube vaporizer wherein the shell-and-tube vaporizer comprises a heating medium comprising a mixture of water and antifreeze.

11. The floating storage regasification unit of claim 1, further comprising a fender.

12. The floating storage regasification unit of claim 1, further comprising a ballast storage area.

13. The floating storage regasification unit of claim 1, further comprising a natural gas pipeline.

14. The floating storage regasification unit of claim 1, wherein the floating storage regasification unit has a storage capacity which is based on factors comprising: the liquefied natural gas capacity of a liquefied natural gas carrier, the desired peak capacity of the floating storage regasification unit for converting liquefied natural gas to natural gas, the rate at which liquefied natural gas from a liquefied natural gas carrier is transferred to a liquefied natural gas storage tank, the need for additional buffer storage, the cost associated with operating the floating storage regasification unit, and combinations thereof.

15. The floating storage regasification unit of claim 1, comprising an upper surface and a bottom surface wherein at least a portion of the upper surface is above a surface of the body of water and wherein at least a portion of the bottom surface is below a surface of the body of water.

16. A method of installing the floating storage regasification unit of claim 1 in a body of water comprising:
towing the floating storage regasification unit to a location in the body of water, wherein the floating storage regasification unit comprises a liquefied natural gas storage tank; and
mooring the floating storage regasification unit to a first mooring system wherein the first mooring system is configured to moor the floating storage regasification unit at a location in the body of water.

17. The floating storage regasification unit of claim 16, further comprising a second mooring system, wherein the second mooring system is configured to moor a liquefied natural gas carrier to the floating storage regasification unit.

18. The floating storage regasification unit of claim 16, wherein the first mooring system is selected from the group consisting of external turret mooring systems, internal turret mooring systems, yoke mooring systems, and combinations thereof.

19. A method of distributing natural gas from a floating storage regasification unit positioned in a body of water comprising:
delivering liquefied natural gas to the floating storage regasification unit, the floating storage regasification unit comprising:
a liquefied natural gas storage tank contained within the floating storage regasification unit;
liquefied natural gas transfer equipment, wherein the liquefied natural gas transfer equipment is configured to transfer liquefied natural gas from a liquefied natural gas carrier to the liquefied natural gas storage tank;
vaporization equipment, wherein the vaporization equipment is configured to vaporize liquefied natural gas to natural gas;
a natural gas pipeline; and
an export metering system;
wherein the floating storage regasification unit floats in a body of water; and
delivering natural gas through the natural gas pipeline to an on-shore natural gas pipeline system.

20. A method of using a floating storage regasification unit in a body of water, comprising:
receiving liquefied natural gas from a liquefied natural gas carrier;
storing the liquefied natural gas in a liquefied natural gas storage tank; and
processing the liquefied natural gas using vaporization equipment.
